(19) United States
(12) Patent Application Publication
(10) Pub. No.: US 2019/0122200 A1
(43) Pub. Date: Apr. 25, 2019

(54) ROBOTIC BEACON DEVICE AND SYSTEM FOR REMOTE TRIGGERING OF EVENTS

(71) Applicant: Bank of America Corporation, Charlotte, NC (US)

(72) Inventor: Manu Jacob Kurian, Dallas, TX (US)

(21) Appl. No.: 15/791,956

(22) Filed: Oct. 24, 2017

(51) Int. Cl. G06Q 20/32; G06Q 20/40; G06F 19/00; G06Q 20/12; H04L 29/08; H04W 4/04

(52) U.S. Cl. CPC G06Q 20/3224; G06Q 20/405; G06F 19/323; H04W 4/04; G06Q 20/12; H04L 67/306; G06F 19/3418

(57) ABSTRACT

Embodiments of the present invention provide a system for remotely triggering execution of events by a robotic process automation system in response to detection of a triggering signal. A set of executable events or actions may be received and stored for future processing, where the set of executable events are to be executed in direct response to a remote monitoring device or beacon detecting the presence of the triggering signal as it is emitted from a mobile device. The remote monitoring device is then instructed to scan a geographic area for the triggering signal. Once the remote monitoring device detects the triggering signal, an indication of the detection is automatically transmitted to the robotic process automation system. This robotic process automation system then automatically executes one or more events from the set of executable events through communication with one or more disparate devices or systems.

### BACKGROUND

Manual interactions between users and third parties that traditionally involve the manual or face-to-face conveyance of data and information are inefficient, slow, and often insecure processes that reduce productivity and security for all parties involved. Utilizing remote monitoring devices as beacons to trigger robotic process automation would improve the efficiency, speed, and data security of these of previously manual interactions.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for remotely triggering execution of events by a robotic process automation system in response to detection of a triggering signal. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving, from a computing device of a user, a user-defined predetermined action to be performed in response to a remote monitoring device detecting a triggering signal from a mobile device. The system may then cause the remote monitoring device to scan a geographical region for the triggering signal from the mobile device and receive, from the remote monitoring device, an indication that the triggering signal from the mobile device is received. In response to receiving the indication that the triggering signal is received, the system may transmit the triggering signal to a robotic process automation system configured to execute the predetermined action.

In some embodiments of the system, the user-predefined action comprises a pre-authorization request for a transaction with a merchant at a merchant location, wherein the remote monitoring device is located at the merchant location, wherein the transaction comprises a product or service of the merchant and a known transaction amount or a transaction amount limit. Additionally or alternatively, the user-predefined action may comprise an approval to use an account of the user to execute the transaction at the known transaction amount or at or below the transaction amount limit. In such embodiments, the system may then pre-authorize the transaction with the merchant. Furthermore, in some such embodiments, executing the predetermined action comprises transmitting, to a computing device of the merchant, an indication that the transaction is pre-authorized and receiving a transaction confirmation from the computing device of the merchant. Finally, in some embodiments, in response to receiving the transaction confirmation, executing the predetermined action may further comprise transmitting an indication of the transaction confirmation to the mobile device.

In some such embodiments, the remote monitoring device of the system is positioned at a location associated with the product or service of the merchant at the merchant location.

The mobile device of the system may be the computing device of the user or may be one or more computing devices of at least one different user.

Additionally or alternatively, the user's approval to use the account of the user to execute the transaction further comprises an approval for the system to transfer the known transaction amount or the transaction amount limit to a separate account or an escrow account. In such embodiments, the processing device of the system is further configured to execute the computer-readable program code to transfer, prior to causing the remote monitoring device to scan the geographical region, the known transaction amount or the transaction amount limit to the separate account or the escrow account. Finally, in some such embodiments, executing the predetermined action further comprises transferring the known transaction amount or the transaction amount limit from the separate account or the escrow account to an account associated with the merchant.

In some embodiments, the system may cause the remote monitoring device to scan the geographical region for the triggering signal from the mobile device during a predetermined period of time. In such embodiments, the system may receive, from the remote monitoring device, the indication that the triggering signal from the mobile device is received within the predetermined period of time and, in response to receiving the indication that the triggering signal is received within the predetermined period of time, the system can transmit the triggering signal to the robotic process automation system configured to execute the predetermined action.

In some embodiments of the system, the user-defined predetermined action comprises a transmission of medical and personal information associated with the user to a computing device of a medical organization associated with the remote monitoring device, wherein the medical and personal information associated with the user comprises at least user allergy information, user prescribed medication information, user blood type information, and user insurance information. In some such embodiments, executing the predetermined action comprises transmitting, to the computing device of the medical organization, the medical and personal information associated with the user.

Finally, in some embodiments of the system, the user-defined predetermined action comprises a transmission of a medical emergency notification to a computing device of a second user that is an emergency contact for the user. In some such embodiments, executing the predetermined action comprises transmitting, to the computing device of the second user, the medical emergency notification.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for remotely triggering execution of events by a robotic process automation system in response to detection of a triggering signal, in accordance with an embodiment of the invention;

FIG. 2 provides a block diagram illustrating the managing entity system of FIG. 1, in accordance with an embodiment of the invention;

FIG. 3 provides a block diagram illustrating the robotic process automation system of FIG. 1, in accordance with an embodiment of the invention;

FIG. 4 provides a block diagram illustrating the computing device system in FIG. 1, in accordance with an embodiment of the invention;

FIG. 5 provides a flowchart illustrating a process for remotely triggering execution of events by a robotic process automation system in response to detection of a triggering signal, in accordance with an embodiment of the invention;

FIG. 6 provides a flowchart illustrating a process for remotely triggering execution of merchant transaction events by a robotic process automation system in response to detection of a triggering signal from a mobile device, in accordance with an embodiment of the invention; and

FIG. 7 provides a flowchart illustrating a process for remotely triggering execution of medical information transferring events, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide a system for remotely triggering execution of events by a robotic process automation system in response to detection of a triggering signal. A set of executable events or actions may be received and stored for future processing, where the set of executable events are to be executed in direct response to a remote monitoring device or beacon detecting the presence of the triggering signal as it is emitted from a mobile device. The remote monitoring device is then instructed to scan a geographic area for the triggering signal. Once the remote monitoring device detects the triggering signal, an indication of the detection is automatically transmitted to the robotic process automation system. This robotic process automation system then automatically executes the set of executable events through communication with one or more disparate devices or systems.

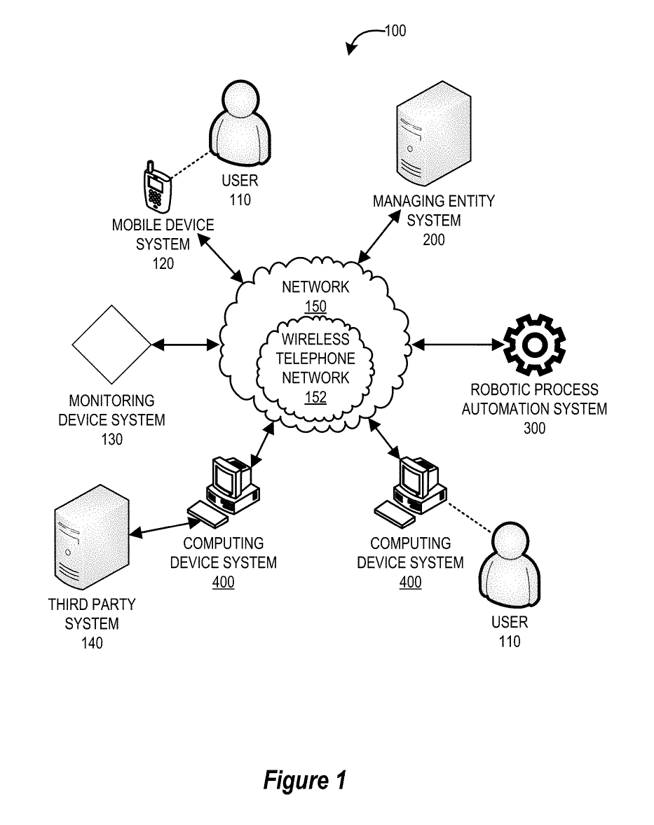

FIG. 1 provides a block diagram illustrating a system environment 100 for remotely triggering execution of events by a robotic process automation system in response to detection of a triggering signal, in accordance with an embodiment of the invention. As illustrated in FIG. 1, the environment 100 includes a managing entity system 200, a robotic process automation system 300, one or more computing device systems 400, a mobile device system 120, a monitoring device system 130, and/or a third party system 140. One or more users 110 may be included in the system environment 100. As used herein, the term “user” 110 may refer to an individual or a plurality of individuals that are associated with the one or more mobile device systems 120 of the system environment 100. In some embodiments, a user 110 may be a client, customer, or otherwise affiliated with the managing entity system 200. For example, a user 110 may be enrolled in a service for remotely triggering execution of certain events associated with the managing entity in response to a monitoring device (e.g., a beacon) detecting a triggering signal from the mobile device of the user 110.

The managing entity system 200, the robotic process automation system 300, the computing device system 400, the mobile device system 120, the monitoring device system 130, and/or the third party system 140 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In some embodiments, the network comprises or includes a wireless telephone network 152.

The managing entity system 200 may be a system owned or otherwise controlled by a managing entity to perform one or more process steps described herein. In some embodiments, the managing entity is a financial institution. In general, the managing entity system 200 is configured to communicate information or instructions with the robotic process automation system 300, the computing device system 400, the mobile device system 120, the monitoring device system 130, and/or the third party system 140 across the network 150.

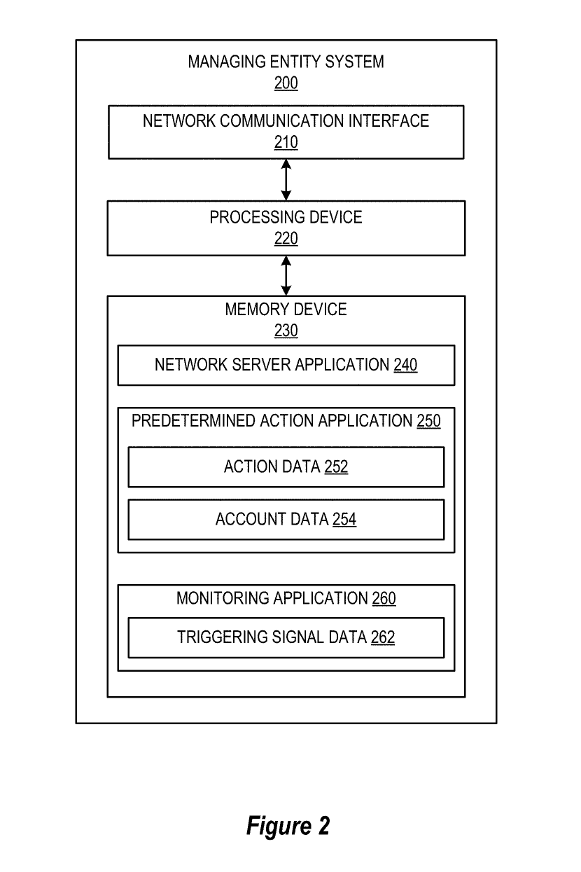

For example, the managing entity system 200 may receive user 110 pre-defined actions from a computing device system 400 or mobile device system 120 of the user 110. The managing entity system 200 may also transmit a command over the network 150 to cause the monitoring device system 130 to scan for a triggering signal from a mobile device system 120. Furthermore, the managing entity system 200 may be configured to receive, from the monitoring device system 130, an indication that the triggering signal is detected and instruct the robotic process automation system 300 to execute at least a portion of a predetermined action. Of course, the managing entity system 200 may be configured to perform (or instruct other systems to perform) one or more other process steps described herein. The managing entity system 200 is described in more detail with respect to FIG. 2.

The robotic process automation system 300 may by a system owned or controlled by the managing entity and/or a third party that specializes in utilizing robotic process automation tools and devices to perform highly technical and/or resource-intensive steps to improve the efficiency and accuracy of an overall system or network environment (e.g., the system environment 100). In general, the robotic process automation system 300 is configured to communicate information or instructions with the managing entity system 200, the computing device system 400, the mobile device system 120, the monitoring device system 130, and/or the third party system 140 across the network 150.

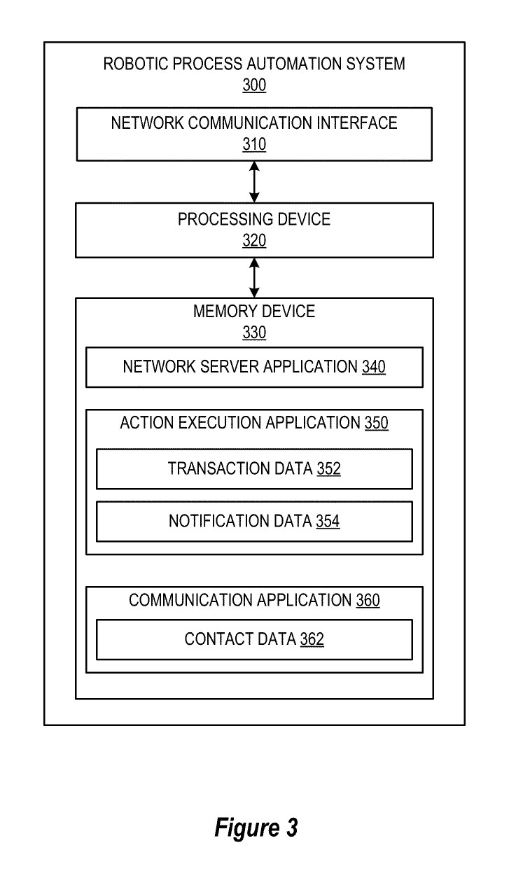

For example, the robotic process automation system 300 may receive instructions from the managing entity system 200 that cause the remote monitoring device system 130 to scan a geographical region for a triggering signal. Additionally, in response to detecting the triggering signal, the robotic process automation system 300 may also transmit an indication that the triggering signal is detected to the managing entity system 200. Of course, the robotic process automation system 300 may be configured to perform (or instruct other systems to perform) one or more other process steps described herein. The robotic process automation system 300 is described in more detail with respect to FIG. 3.

The computing device system 400 may by a system owned or controlled by the managing entity, a user, and/or a third party that specializes in using one or more computing devices to provide predetermined actions to the managing entity system 200, receive instructions from a monitoring device system 130 and/or the managing entity system 200 to perform certain tasks, and the like. In general, the computing device system 400 is configured to communicate information or instructions with the managing entity system 200, the robotic process automation system 300, the mobile device system 120, the monitoring device system 130, and/or the third party system 140 across the network 150.

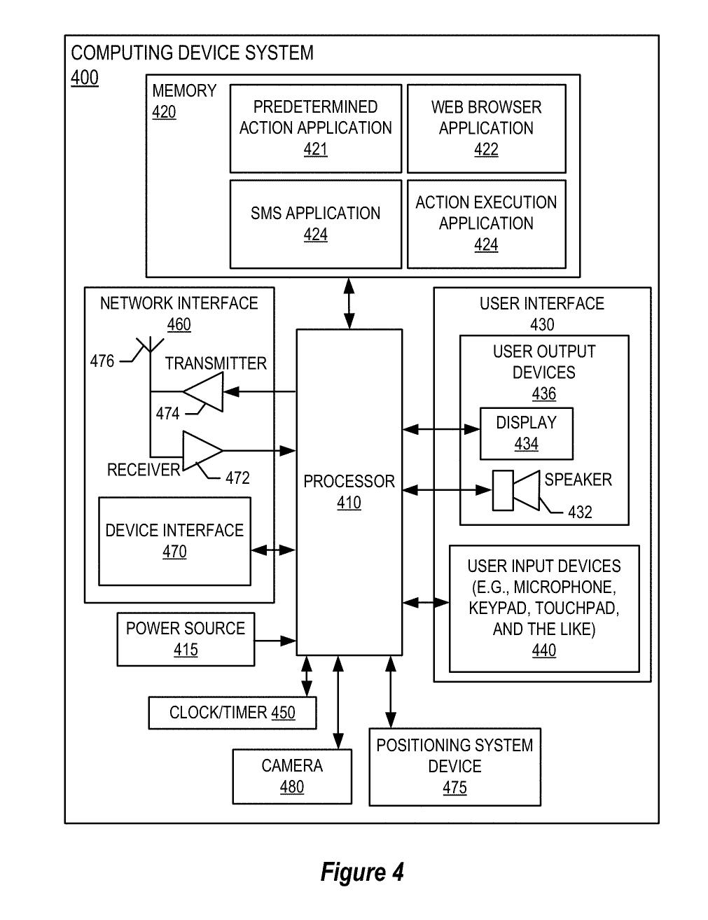

For example, the computing device system 400 may receive a predetermined action from a user 110 (e.g., via a user interface of the computing device system 400), transmit the predetermined action to the managing entity system 200, receive a notification from the robotic process automation system 300 comprising information about a transaction, medical information, and/or personal information, and the like. Of course, the computing device system 400 may be configured to perform (or instruct other systems to perform) one or more other process steps described herein. The computing device system 400 is described in more detail with respect to FIG. 4.

The mobile device system 120 may be, in some embodiments, a computing device (e.g., the computing device system 400) capable of moving around in a manner associated with a location of a user 110 or other individual. The mobile device system 120 may be configured to emit a triggering signal (e.g., at all times, when within a predetermined geographic area, when prompted by a user or other owner of the mobile device system 120, and the like. In some embodiments, the mobile device system 120 is a mobile telephone (e.g., a smartphone). In other embodiments, the mobile device system 120 comprises a wearable device (e.g., a smartwatch, a pager, smart glasses, a mobile electronic chip, an electronic tag, and the like).

The monitoring device system 130 may be any beacon, signal detector, computing device, scanning device, electronic tag, signal receiver, or any combination thereof. The monitoring device system 130 may be configured to cause a scanning portion to scan a geographical region for a triggering signal (e.g., from a mobile device system 120), detect the triggering signal, and transmit an indication that the triggering signal has been detected to the managing entity system 200 and/or the robotic process automation system 300. In some embodiments, the monitoring device system 130 is closely connected to (e.g., via a wireline connection) a third party system 140 like a merchant system, a medical organization system, a toll system, a classroom or meeting room attendance system, a group payment system, or the like.

In some embodiments, multiple monitoring devices are utilized within a monitoring device system 130. For example, multiple monitoring devices may be positioned throughout a merchant's store: a first monitoring device positioned at or near a location of a first product or service and a second monitoring device positioned at or near a location of a second product or service. In this way, the specific (i.e., first or second) monitoring device may be instructed to scan a geographic area (i.e., the first location or second location) for the triggering signal.

The third party system 140 may be any system that owns, operates, or is otherwise associated with the monitoring device system 130. In some embodiments, the managing entity system owns the monitoring device system 130, but at least a portion of the monitoring device system (e.g., a signal scanning or detecting device) may be positioned at a location of the third party that controls the third party system 140.

Additionally or alternatively, the robotic process automation system 300 may be closely associated with a location of the third party of the third party system 300 such that notifications, instructions, and the like can be automatically transmitted from the robotic process automation system 300 to and/or from the third party system 140. For example, the robotic process automation system 300 may transmit instructions to the third party system 140 to execute a transaction, transmit an indication that a user (e.g., user 110) is authenticated, validated, or otherwise authorized to engage in a transaction with the third party system 140.

The third party that owns, controls, or is otherwise associated with the third party system may be a business, organization, or other group that engages in the system for remote triggering of events. As such, the third party system 140 may be associated a merchant like a retail merchant, financial institution, toll road operating institution, government institution, academic organization or school, restaurant, travel organization, a shipping or logistic company, and the like. In other embodiments, the third party system 140 is associated with a medical organization like a hospital, urgent care center, medical insurance agency, emergency medical services organization, emergency contact notification organization, primary care group, and the like. Of course, other types of third parties (or multiple third parties) may be associated with the third party system 140 in the system environment 100.

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution, while in other embodiments, the managing entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a predetermined action application 250 which includes action data 252 and account data 254, a monitoring application 260 which includes a triggering signal data 262, and other computer-executable instructions or other data. The computer-executable program code of the network server application 240, the predetermined action application 250, and/or the monitoring application 260 may instruct the processing device 220 to perform certain logic, data-processing, and data-storing functions of the managing entity system 200 described herein, as well as communication functions of the managing entity system 200.

In one embodiment, the predetermined action application 250 includes action data 252 and account data 254. The action data 252 may comprise information, instructions, requests, and the like that are associated with one or more actions that should take place in direct response to a monitoring device detecting a triggering signal from a mobile device.

The account data 254 may include information about one or more financial accounts of a user (e.g., the user 110). Furthermore, the account data may include information about escrow accounts, or other accounts that are not tied directly to the user, but that may be used as a go-between from the account of the user and a transaction terminal of a merchant.

In one embodiment, the monitoring application 260 includes triggering signal data 262. This triggering signal data 262 may include information about what a triggering signal will comprise, when the triggering signal should be emitted from the mobile device, how long the triggering signal should be emitted from the mobile device, geographic regions where the triggering signal should be emitted, and the like.

The network server application 240, the predetermined action application 250, and/or the monitoring application 260 are configured to invoke or use the action data 252, the account data 254, the triggering signal data 262, and the like when communicating through the network communication interface 210 with the robotic process automation system 300, the computing device system 400, the mobile device system 120, the monitoring device system 130, and/or the third party system 140 of the system environment 100.

As used herein, a “communication interface” generally includes a modem, server, transceiver, and/or other device for communicating with other devices on a network, and/or a user interface for communicating with one or more customers. Referring again to FIG. 2, the network communication interface 210 is a communication interface having one or more communication devices configured to communicate with one or more other devices on the network 150, such as the robotic process automation system 300, the computing device system 400, the mobile device system 120, the monitoring device system 130, the third party system 140, and the like. The processing device 220 is configured to use the network communication interface 210 to transmit and/or receive data and/or commands to and/or from the other devices connected to the network 150.

FIG. 3 provides a block diagram illustrating the robotic process automation system 300, in greater detail, in accordance with embodiments of the invention. As illustrated in FIG. 3, in one embodiment of the invention, the robotic process automation system 300 includes one or more processing devices 320 operatively coupled to a network communication interface 310 and a memory device 330. In certain embodiments, the robotic process automation system 300 is operated by a first entity, such as a financial institution, while in other embodiments, the robotic process automation system 300 is operated by an entity other than a financial institution.

It should be understood that the memory device 330 may include one or more databases or other data structures/repositories. The memory device 330 also includes computer-executable program code that instructs the processing device 320 to operate the network communication interface 310 to perform certain communication functions of the robotic process automation system 300 described herein. For example, in one embodiment of the robotic process automation system 300, the memory device 330 includes, but is not limited to, a network server application 340, an action execution application 350 which includes transaction data 352 and notification data 354, a communication application 360 which includes contact data 362, and other computer-executable instructions or other data. The computer-executable program code of the network server application 340, the action execution application 350, and/or the communication application 360 may instruct the processing device 320 to perform certain logic, data-processing, and data-storing functions of the robotic process automation system 300 described herein, as well as communication functions of the robotic process automation system 300.

In one embodiment, the action execution application 350 includes transaction data 352 and notification data 354. The transaction data 352 may comprise approved transaction amounts from the user, transaction amount limits or maximums set by the user, transaction amounts requested by merchants, and the like.

The notification data 354 may include data or information that a user has requested to be sent to an emergency contact, medical or personal data or information that the user has requested to be sent to a medical organization, and the like. As such, the notification data may be encrypted when stored and/or when transmitted to the emergency contact and/or the medical organization.

In one embodiment, the communication application 360 includes contact data 362. This contact data 362 may include information about how to contact a computing device of a merchant, a computing device of the user, a computing device of a medical organization, a computing device of a medical organization, and the like.

The network server application 340, the action execution application 350, and/or the communication application 360 are configured to invoke or use the transaction data 352, the notification data 354, the contact data 362, and the like when communicating through the network communication interface 310 with the managing entity system 200, the computing device system(s) 400, the mobile device system 120, the monitoring device system 130, and/or the third party system 140.

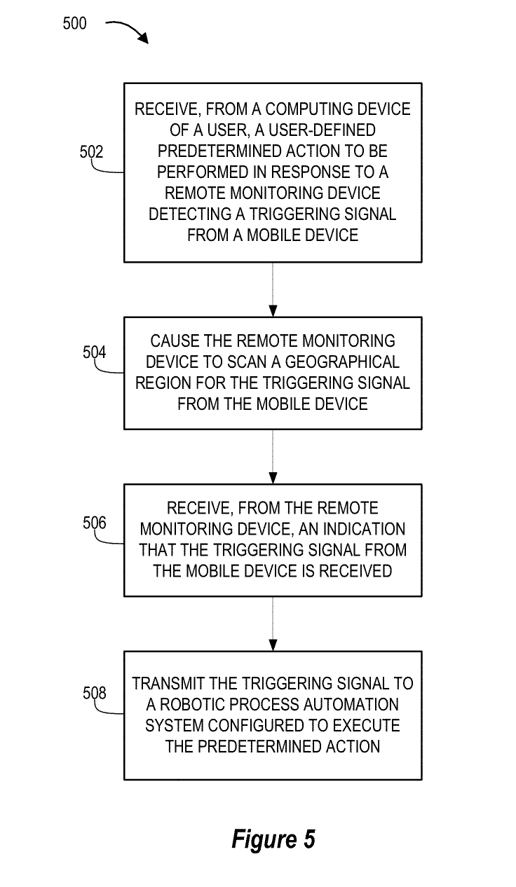

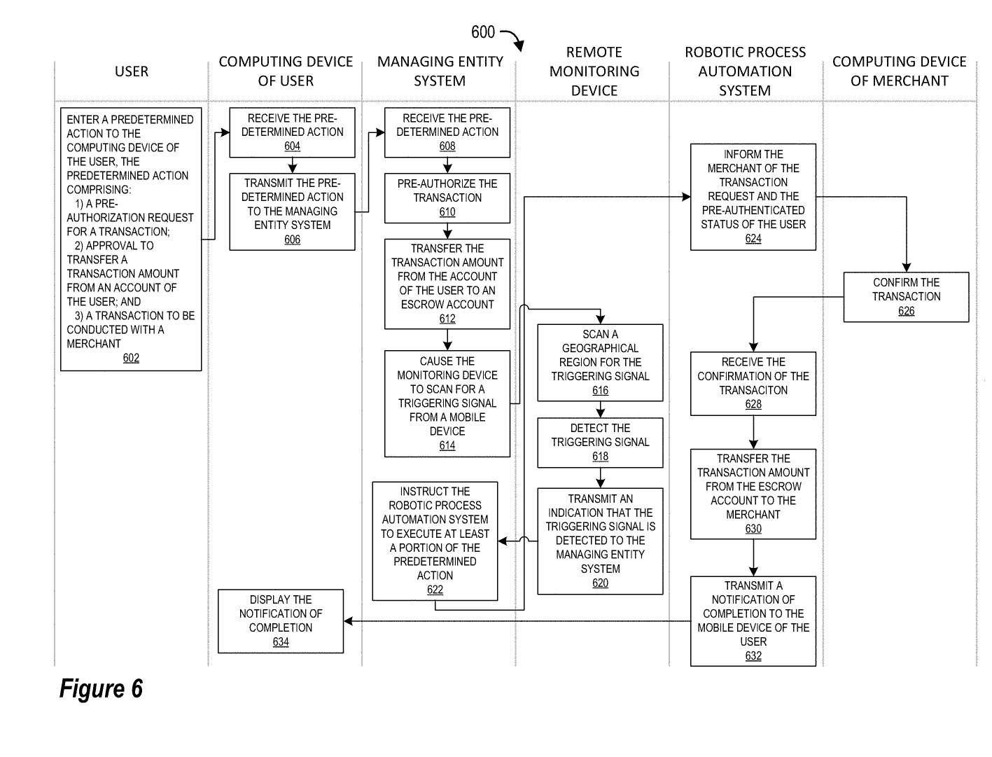

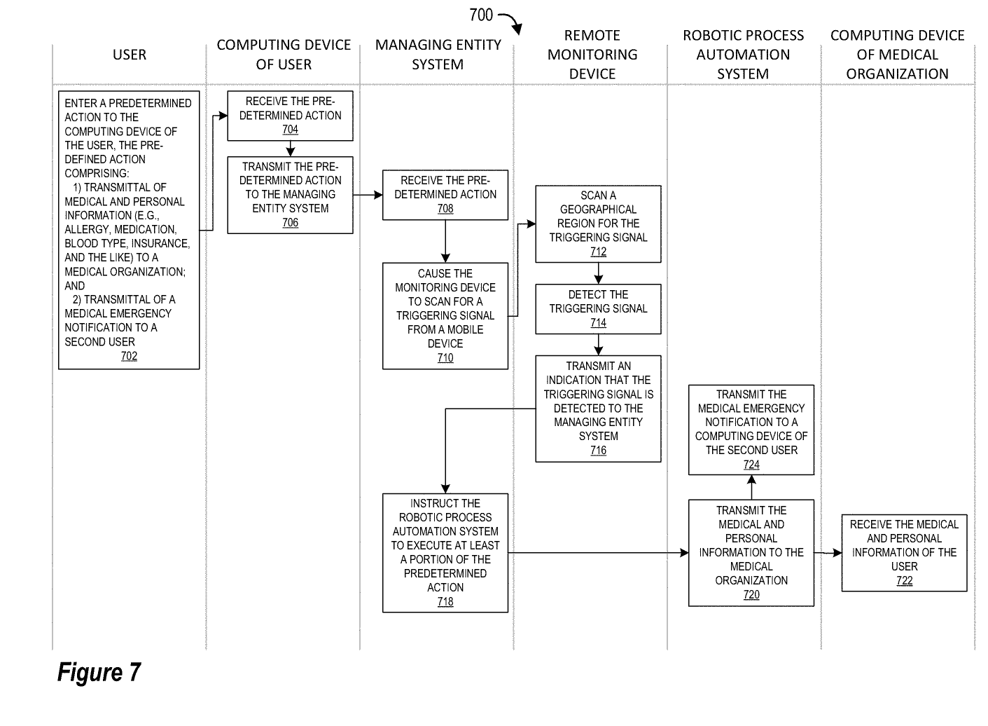

The robotic process automation system 300 may comprise a single robotic process automation device or tool comprising the components described herein that is configured to perform some or all actions of the robotic process automation system 300 as described herein (e.g., process 500 of FIG. 5, process 600 of FIG. 6, and process 700 of FIG. 7).

In other embodiments, multiple robotic process automation devices or tools may make up the robotic process automation system 300, where the multiple robotic process automation devices or tools may be configured to execute certain process steps described herein in parallel. For example, the resource intensive steps like securely transmitting personal or medical data to a computing device of a medical organization may be executed using several robotic process automation tools at once, where each robotic process automation tool performs a portion of the overall identification, encryption, and/or transfer of personal or medical data. In this way, the robotic process automation system can perform robust and resource-intensive actions in a shorter amount of time with a more specialized approach that is beneficial to the successful execution of the predetermined actions than those approaches that require manual interaction or intervention.

FIG. 4 provides a block diagram illustrating a computing device system 400 of FIG. 1 in more detail, in accordance with embodiments of the invention. In one embodiment of the invention, the computing device system 400 is a mobile telephone. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices of the computing device system 400 may include personal computers, work stations, desktop computers, servers, portable digital assistants (PDAs), pagers, mobile televisions, gaming devices, laptop computers, cameras, video recorders, audio/video player, radio, global positioning system (GPS) devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface 430 that is, like other user interfaces described herein, made up of user output devices 436 and/or user input devices 440. The user output devices 436 include a display 434 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface 430 may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices. The positioning system device 475 may play a crucial role in transmitting location information associated with the computing device system 400 (e.g., the mobile device system 120) for determining when the computing device system 400 is in at or is in close proximity to a merchant or other third party associated with a third party system 140.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a predetermined action application 421, an action execution application 424, or any other application provided by the managing entity system 200. These applications also typically provide instructions to a graphical user interface (GUI) on the display 434 that allows the user 110 to interact with the computing device system 400, the managing entity system 200, and/or other devices or systems. In one embodiment of the invention, when the user 110 decides to enroll in a predetermined action application 421 program, the user 110 downloads, is assigned, or otherwise obtains the predetermined action application 421 from the managing entity system 200, or from a distinct application server (e.g., from the third party system 140). In other embodiments of the invention, the user 110 interacts with the managing entity system 200 via the web browser application 422 in addition to, or instead of, the predetermined action application 421 and/or the action execution application 424.

The memory 420 of the computing device system 400 may comprise a Short Message Service (SMS) application 423 configured to send, receive, and store data, information, communications, alerts, and the like via the wireless telephone network 152.

The predetermined action application 421 may be configured to receive user input comprising the predetermined action. In some embodiments, the predetermined action is entered as a set of predetermined action steps that need to be completed.

The action execution application 424 may be configured to perform one or more of the predetermined actions. For example, a computing device of a merchant may receive a pre-authorization notification and a request for the execution of a transaction from a robotic process automation system. The action execution application 424 may be configured to approve the pre-authorization and the transaction in general, along with setting up the communication link with the robotic process automation system necessary to transfer the transfer amount from an escrow account to an account associated with the merchant.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein. For example, the memory 420 may include such data as triggering signal data, and the like.

Referring now to FIG. 5, a flowchart is provided to illustrate one embodiment of a process 500 for remotely triggering execution of events by a robotic process automation system in response to detection of a triggering signal, in accordance with embodiments of the invention. In some embodiments, the process 500 may include block 502, where the system receives, from a computing device of a user, a user-defined predetermined action to be performed in response to a remote monitoring device detecting a triggering signal from a mobile device.

As used herein, the term “predetermined action” refers to one or more action steps that are to be completed either prior to or in direct response to the remote monitoring device detecting the triggering signal from the mobile device. In some embodiments, one or more of the action steps of the predetermined action may be executed by a managing entity system and/or a robotic process automation system prior to the detection of the triggering signal by the remote monitoring device. For example, if a user needs to be authenticated prior to a predetermined action of a transaction, the system may authenticate the user prior to moving forward with the rest of the process 500. As such, the system may be configured to perform one or more steps (e.g., background steps or preparation steps) between block 502 and block 504 such that the system is prepared to trigger the remaining action steps of the predetermined action.

While not illustrated in FIG. 5, in some embodiments, the system may determine whether one or more of the action steps of the predetermined action require completion prior to the triggering signal being detected by the remote monitoring device. When the system determines that each remaining action step is prepared to be executed by the robotic process automation system, the system may transmit a command to the mobile device, instructing the mobile device to begin emitting the triggering signal.

In some embodiments, the transmitted command to the mobile device causes the mobile device to emit the triggering signal in response to certain limitations. For example, the instructions may be for the mobile device to emit the triggering signal for a set period of time (e.g., one hour, one day, one week, and the like), when within a certain geographic area (e.g., within a city or region, based on global positioning system information), when within a predetermined distance from the remote monitoring device (such that the mobile device does not transmit the triggering signal when located in areas were the remote monitoring device could not detect the triggering signal), and the like.

In other embodiments, the operator of the mobile device (e.g., the user, a different user, a group of users, or the like) may prompt the mobile device to begin transmitting the triggering signal (e.g., immediately, at a particular time, for a set time period, for recurring sets of time periods (e.g., during daylight hours every Friday), and the like.

The mobile device from which the triggering signal is sent may, in some embodiments, be the same device as the computing device of the user. In other embodiments, the mobile device is a mobile device of a different user. Additionally, the user-defined predetermined action may requested to be performed in response to the remote monitoring device detecting a plurality of triggering signals from a plurality of mobile devices. For example, the predetermined action may require the presence of multiple users (e.g., the user and one or more other users). Therefore, mobile devices of each of the multiple users would need to be present at the same location (i.e., detectable by the remote monitoring device) before the predetermined action should occur.

The mobile device may be any type of portable communication device, such as a cellular telecommunications device (i.e., a cell phone or mobile phone), a personal digital assistant (PDA), a mobile Internet accessing device (e.g., a portable Internet of things device), a tablet computer, a laptop, smartwatch, an electronic chip that emits signals (i.e., the triggering signal), or the like. In some embodiments, the location of the mobile device is closely associated with the location of the user, as the user is wearing, using, carrying, or is otherwise normally in close proximity to the mobile device. In this way, when a remote monitoring device detects the triggering signal being emitted from the mobile device, the system can make an assumption that the user is in close proximity to the location of the mobile device and therefore also in close proximity to the remote monitoring device.

In some embodiments, the process 500 includes block 504, where the system causes the remote monitoring device to scan a geographical region for the triggering signal from the mobile device. The system may include multiple remote monitoring devices. In such embodiments, the predetermined action may identify a particular remote monitoring device (or a plurality of the remote monitoring devices) that should be instructed to scan their respective geographical regions for the triggering signal from the mobile device. The scanning and detection of the triggering signal may be touchless for the user and/or the remote monitoring device.

The remote monitoring device may actively scan for the triggering signal, actively ping the geographical area for the mobile device to return the triggering signal, or the like. The remote monitoring device may be paired with a product or service at a merchant, a particular door at a merchant or medical facility, a particular lane at a toll road charging point, or the like. In these cases, the remote monitoring device may be configured to scan only the geographical area closely associated with those specific locations or objects. By tailoring the scanning region of the remote monitoring devices, the system can determine whether the mobile device is in close proximity to the particular product at the merchant, the door or other specific location within the medical facility, the particular lane at the toll road charging point, and the like.

In some embodiments, the remote monitoring device is movable such that it remains in close proximity to a merchant that moves (e.g., a food truck, train or other transportation operator, private seller, and the like). For example, a private seller may own a mobile device that is configured to operate as the remote monitoring device that scans a geographical region around it for the triggering signal. In such embodiments, the system causes this mobile device of the private seller to scan for the triggering signal.

The system may, in some embodiments, cause the remote monitoring device to scan for the triggering signal only during a set, predetermined period of time (e.g., during certain hours of the day, for a period of time from when the predetermined action is received, for a set number of days, for a specific period of time immediately following a determination that the mobile device is within a predetermined distance of the remote monitoring device, and the like).

Once the remote monitoring device has detected the triggering signal from the mobile device (or the multiple triggering signals from the multiple mobile devices), the system may proceed to block 506 where the system receives, from the remote monitoring device, an indication that the triggering signal from the mobile device is received. The transmittal of the indication from the remote monitoring device to the system may be performed automatically in direct response to the remote monitoring device detecting the triggering signal. While FIG. 5 illustrates this embodiment where the indication that the triggering signal has been received, it should be known that the remote monitoring device may, in some embodiments, automatically transmit the indication to the robotic process automation system instead of, or in addition to, the overall or managing system.

In embodiments where the remote monitoring device is to scan for the triggering signal only for a predetermined period of time, the system may check to confirm whether the received triggering signal is received within the predetermined period of time or not. If the system determines that the triggering system was not received within the predetermined period of time, the system may end the process 500, or at least hold off from proceeding to block 508. However, if the system determines that the triggering signal was detected within the predetermined period of time, the system may proceed to block 508.

Finally, the process 500 proceeds to block 508, where the system transmits the indication that the triggering signal was detected to a robotic process automation system configured to execute the predetermined action. In embodiments where one or more of the action steps that comprise the predetermined action have already been performed by the overall system (e.g., user authentication, user verification, transfer of funds from an account of the user to an escrow account, and the like), the robotic process automation system is configured to execute only the remaining action steps of the predetermined action.

The robotic process automation system may utilize a robotic process automation device and/or tool to perform each of the action steps in the predetermined action. In some embodiments, the robotic process automation system is a component of the managing entity system and therefore no transmittal of the data is necessary. For example, the robotic process automation system may comprise a robotic process automation tool that is a component of the managing entity system. Instead, the system can transmit a request for the robotic process automation system to execute the action steps of the predetermined action.

Referring now to FIG. 6, a flowchart is provided to illustrate one embodiment a process 600 for remotely triggering execution of merchant transaction events by a robotic process automation system in response to detection of a triggering signal from a mobile device. The merchant of this process 600 may be any entity, organization, private seller, or the like that has at least one computing device that is configured to communicate with the other devices and systems of the process 600 as described herein. For example, illustrative purposes, the merchant may be a gas station, a retail store, a restaurant, a financial institution, a service-based organization, a toll road operator, a stadium or sporting event organizer, or the like.

The process 600 begins with block 602, where a user enters a predetermined action to the computing device of the user (e.g., a personal computer of the user, a mobile computing device of the user, a computing device of a managing entity system, or the like). The predetermined action may comprise one or more action steps that are to be completed in response to a remote monitoring device detecting a triggering signal from a mobile device. In some embodiments, one or more of the action steps of the predetermined action may be executed by the managing entity system and/or a robotic process automation system prior to the detection of the triggering signal by the remote monitoring device.

For example, and as illustrated in block 602, the user pre-defined action may comprise a pre-authorization request for a transaction with a particular merchant. The pre-authorization request may include a transaction amount, the merchant information, the product and/or service that will be purchased in the transaction, and the like. The managing entity system may then be able to pre-authorize the user prior to the remote monitoring device detecting the triggering signal, such that the user authorization step is performed prior to an interaction with the user and the merchant. This bypasses the time and processing requirements of a merchant computing device (e.g., a point of sale device) communicating with both the user and a financial institution of the user (e.g., the managing entity) to authorize the user ahead of time.

Similarly, the user pre-defined action may comprise an approval to transfer a transaction amount (e.g., a purchase price, a maximum purchase price, a total transaction amount, or the like) from an account (e.g., a financial account) of the user. As described herein, this request will be handled in multiple parts by the process 600, with the transaction amount being confirmed as being present in the account of the user, and being transferred to a separate account (e.g., an escrow account) prior to the triggering signal being detected by the remote monitoring device. In this way, the managing entity system and/or the robotic process automation system can set aside and prepare for the transfer of funds prior to a user actually interacting with the merchant, thereby bypassing the time and resources normally borne by a new in-person transaction between the user and the merchant.

Finally, block 602 notes that the user-defined predetermined action may include an execution of the transaction with the merchant. This predetermined action of an execution of the transaction may be a one-time request (e.g., for a particular product or service, for a unique or specialized product or service, or the like). In other embodiments, the predetermined action for the execution of the transaction may be for a product or service that the user frequently or regularly purchases at the merchant (e.g., gas at a gas station, food at a restaurant, coffee at a coffee shop, and the like). As such, each time the user (along with the mobile device of the user) is present at the merchant, the triggering signal will be detected and the robotic process automation system will carry out a transaction on behalf of the user. For example, each time a remote monitoring device positioned at a gas station (e.g., on a particular pump at the station) detects the triggering signal from the mobile device of the user, the robotic process automation system will (i) inform the merchant that the user is pre-authorized to pump gas up to a maximum transaction amount and (ii) execute payment of the transaction amount (up to the maximum transaction amount) for the gas that is pumped by the user. Of course, this is simply one example of how the process 600 will work, based on the user-defined predetermined action that is entered into the computing device of the user, as shown in block 602, and is not meant to be limiting.

This predetermined action is paired with a triggering signal that will be emitted from a mobile device (which may be the computing device of the user).

The computing device of the user will receive the predetermined action, as shown in block 604. For example, the computing device of the user may receive the predetermined action as input from user input devices (e.g., keypad, speaker, and the like) of the computing device of the user.

While the computing device of the user is referenced for this process 600, it should be known that another computing device may be used. For example, a computing device of the managing entity, of the merchant, or of a third party may be used to receive the predetermined action and to transmit the predetermined action to the managing entity system. Additionally or alternatively, the computing device of the user may be the mobile device that will be emitting the triggering signal for detection by the remote monitoring device.

Once the predetermined action has been received, the process may proceed to block 606, where the computing device of the user transmits the predetermined action to the managing entity system. As mentioned above, the managing entity system may be a financial institution, a process automation organization, a logistics company, a regulatory agency, or any other institution that may be able to perform the steps of the managing entity system as described with respect to this process 600 and the rest of this application. For sample purposes, the managing entity system will be considered a financial institution for this description of the process 600.

Once the managing entity system has received the predetermined action from the computing device of the user, the managing entity system can perform the one or more action steps that need to be in place prior to the robotic process automation system's final execution of the pre-determined action. Therefore, in some embodiments, the managing entity system may pre-authorize the transaction at block 610, as requested by the user in block 602. While the term “authorize” is used with respect to the process 600, it should be known that any other form of user authorization, verification, authentication, validation, clearing, certification, endorsement, or the like can be included in (or in the place of) the pre-authorization request. To accomplish this step, the managing entity system may compare information from the user (e.g., identification information, authentication information, authorization information, passwords, account information, and the like) to stored or known information about the user to determine whether the user is authorized to execute the transaction at some point in the future. Once the system determines that the user is per-authorized to enter into the transaction, the system may store an indication of the pre-authorization with the robotic process automation system.

Similarly, the system may ensure that the account of the user will cover the transaction amount or maximum transaction amount, and then transfer the transaction amount from the account of the user to an escrow account (or another separate account), as shown in block 612. By placing the funds of the user, in the amount of the transaction amount (or maximum), in an escrow account, the system can separate the financial information, account information, and other information from the actual transaction such that this information cannot be misappropriated by an individual that intercepts or misappropriates the transaction information in a person-to-person transaction with the merchant (e.g., at a point of sale device). This separation and protection of sensitive information of the user from the information that is to be used during the actual transaction process (e.g., user authentication, user account access, user payment vehicle information, and the like) provides a technical solution to a problem in a transaction scenario where a computing device is confirming an identity of a user and/or confirming that the account of the user is capable of providing the transaction amount during a transaction with a merchant.

Other preliminary action steps may be completed at this point during the process to ensure that all remaining action steps are ready and able to be executed by the robotic process automation system at a later point in time. In some embodiments, the robotic process automation system is the system that executes these preliminary action steps like those shown in block 610 and 612.

Once all preliminary action steps have been completed, the managing entity system may instruct the mobile device (e.g., the computing device of the user, a different computing device of the user, a mobile device of a different user, multiple mobile devices of one or more users, and the like) to emit the triggering signal. As mentioned above, additional instructions may be sent to the mobile device including, but not limited to, instructions for a duration of time that the mobile device should emit the triggering signal, a period of time during which the mobile device should emit the triggering signal, and the like.

Next, the managing entity system may cause the remote monitoring device to scan a geographical region for a triggering signal from a mobile device, as shown in block 614. In some embodiments, the predetermined action may involve a purchase of a particular product (or service) from the merchant. In such embodiments, the remote monitoring device may be positioned at a location that is closely associated with the location of that particular product. For example, the remote monitoring device could be positioned on, above, or near a shelf that contains the particular product. The remote monitoring device could then scan a relatively short geographical area where a mobile device of an individual would likely be present when the individual is acquiring or purchasing the particular product.

In embodiments where the transaction is for gas at a gas station, the remote monitoring device may be positioned on a specific gas pump and configured to scan a geographical region closely associated with where the mobile device would be located if the user (or another operator of the mobile device) was positioned to pump gas at that gas pump. In this way, the system can identify that the user is ready to pump gas, which gas pump the user is at, and the like from the position and configuration of the remote monitoring device. The system is then able to allow the user to pump an amount of gas equivalent to the transaction amount or the transaction amount maximum without requiring the user to interact with the gas pump interface or a gas pump attendant.

In embodiments where the transaction is for a toll road transaction amount, the remote monitoring device may be positioned and directed such that the device scans a particular geographical area of one or more lanes in a road for the triggering signal. In this way, the system can identify when the mobile device (and the user, another individual, and/or a car, by proxy) pass through the toll road transaction amount collection point.

Similarly, one or more remote monitoring devices may be positioned on a bus, train, trolley, or other public transportation vehicle and configured to scan a geographical region associated with being on or within the public transportation vehicle. In this way, the system can identify when the mobile device (and the user or another individual, by proxy) is on the public transportation vehicle.

In some embodiments, the remote monitoring device may be a mobile device itself, where the merchant (e.g., an individual private seller, a delivery person, or the like) carries the mobile monitoring device around (e.g., in a delivery vehicle, on the individual's person, as part of a mobile phone of the merchant, or the like). In such embodiments, the mobile monitoring device is configured to scan whichever geographical region surrounds the mobile monitoring device at that point in time. When the mobile monitoring device detects the triggering signal, the system can determine that the mobile device (and the user or another individual, by proxy) is currently close to the mobile monitoring device.

In other embodiments, the remote monitoring device may be integrated with a vehicle (e.g., a private vehicle, a delivery vehicle, a logistics or other transportation truck, and the like) with computer components comprising a robotic process automation system that is connected to a wireless network for executing action steps. As such, the vehicle and remote monitoring device may be configured to communicate between each other to perform one or more actions described herein.

Furthermore, the managing entity system may automatically engage order processing based on receiving information, feedback, or other indications. For example, a prerequisite of the predetermined action may include the occurrence of an event associated with a calendar date and/or time at which the triggering signal can or should be detected. The managing entity system can monitor a calendar application associated with user to determine the calendar date and time of the prerequisite event and cause the remote monitoring device to scan the geographical region for the triggering signal at the determined calendar date and time.

Similarly, a prerequisite of the predetermined action may include an occurrence of some event, where the managing entity system causes the remote monitoring device to scan for the triggering signal in direct response to determining that the event is occurring or has occurred. For example, in some embodiments where the predetermined event concerns a transaction for gas at a gas station merchant, a prerequisite of the predetermined event may comprise a low fuel level in an automobile of the user. In such embodiments, the automobile (or at least a gas tank system of the automobile) may function as the mobile device as well as a monitoring device for fuel levels within the automobile's gas tank. The automobile of the user may monitor the gas tank to determine when the fuel level is below a threshold level (e.g., one quarter tank remaining) and, in response to determining that the fuel level is below the threshold level, transmit instructions to cause a remote monitoring device at the gas station to begin scanning a geographical region for the triggering signal. Additionally or alternatively, the automobile of the user may begin to act as the mobile device and begin transmitting the triggering signal in response to determining that the fuel level is below the threshold level.

Continuing the gas tank example, the system may recognize that multiple gas station merchants have a remote monitoring device that can be used in the process 600. The system can analyze a known navigation path (e.g., a suggested or known route of the automobile of the user, as found in a navigation application associated with the automobile and/or a mobile device of the user) to identify one or more gas station merchants with a remote monitoring device that are positioned along the known navigation path or within close proximity to the known navigation path.

The system can plot a future point of sale at an ideal gas station merchant based on this analysis of the navigation path, transmit a notification of the future point of sale (including an address and/or directions to the gas station merchant) to the mobile device and/or automobile of the user, and/or cause a navigation application of the user to guide the automobile of the user to the future point of sale location. This point of sale can be adjusted over time if the system detects burdensome traffic, a deviation from the expected navigation path, and the like.

In embodiments, the system may additionally transmit a notification to the merchant of the future point of sale to indicate that the user and the user's automobile are in transit towards the merchant and are expected to enter into a transaction for gas with the merchant. Additional information like requests for assistance in the transaction can be transmitted to the merchant at this point in time. For example, a request for assistance in pumping gas, a request for preparation of one or more additional products (e.g., coffee, snacks, or other products or services provided by the merchant), and the like can be transmitted to the merchant to expedite the future point of sale without requiring unnecessary and inefficient human interaction. Likewise, the system can alert the merchant when changes to the expected time of the future point of sale will occur, thereby ensuring all parties are kept up-to-date on the status of the future transaction.

Moving to block 616, the remote monitoring device then scans the geographical region around it for the triggering signal. As mentioned above, the signal may be received at a signal detection component of the monitoring device. Additionally or alternatively, the remote monitoring device may actively ping its surroundings with a signal that will provoke a response of the triggering signal from the mobile device, if the mobile device is within the geographical region and receives the ping.

The remote monitoring device then detects the triggering signal, as shown in block 618 and transmits an indication that the triggering signal is detected to the managing entity system, as illustrated at block 620. In some embodiments, the transmittal of block 620 is to the robotic process automation system instead of, or in addition to, the managing entity system.

Once the managing entity system 622 has received the transmittal from the remote monitoring device, the managing entity system may instruct the robotic process automation system to execute at least a portion of the predetermined action. The instructions may be to complete the entire predetermined action or, if one or more preliminary action steps (e.g., pre-authorizing the transaction, transferring the transaction amount from the user account to the escrow account, and the like) have been completed, to complete the remaining action steps of the predetermined action.

In this example process 600, the robotic process automation system 624 informs the merchant of the transaction request and the pre-authentication status of the user and to complete the transaction. Informing the merchant may involve transmitting a notification to a computing device of the merchant (e.g., a point of sale device or any other computing device configured to aide in the execution of the transaction of the user), which then can confirm the transaction as shown in block 626. Confirming the transaction may involve agreeing to any terms or conditions of the transaction, agreeing to a set transaction fee (e.g., the transaction fee mentioned above or a new transaction fee that is below the transaction fee maximum set by the user), confirmation that the product or service of the requested transaction is still in stock, and the like.

The robotic process automation system will then receive the confirmation of the transaction at block 628 and transfer the transaction amount from the escrow account to the merchant, as shown at block 630. Again, in this scenario, the managing entity system has already pre-authorized the user and transaction and retrieved the appropriate transaction amount from the account of the user and placed that transaction amount in an escrow account or other separate account. Therefore, the merchant system can rely on the managing entity's expertise in authorizing users and transactions and in securing transaction amounts to carry out the transaction without requiring inefficient interactions with the user (or whichever individual is associated with the mobile device) that could expose the user to misappropriation of the personal and financial information of the user. The merchant does not need to receive an account number, payment vehicle number, confirmation code, biometric information, or any other information that may be part of a manual interaction in this scenario because the user has been authorized by the managing entity to carry out the transaction and the transaction amount comes from an account that is not directly linked to the user.

The robotic process automation system may then transmit a notification of completion to the mobile device of the user, as shown in block 632. This transmittal may cause the computing device of the user to display (e.g., on a user interface of the computing device) the notification of completion of the transaction, as illustrated at block 634. In this way, the robotic process automation system has informed the user that the transaction is complete and that the user may acquire the desired product, that the user has appropriately utilized the toll road, that the user may continue to ride the public transportation vehicle, and the like.

In some embodiments, the notification of completion may comprise a receipt for the product or a ticket for the use of the toll road or public transportation vehicle. In this way, no physical receipt needs to be printed and handed to the user, which again would be an inefficient and burdensome activity for the merchant as well as the user.

Referring now to FIG. 7, a flowchart is provided to illustrate one embodiment of a process 700 for remotely triggering execution of medical information transferring events. This process 700 may be especially useful for a user that would like to make his or her medical and/or personal information available to a predetermined set of medical, insurance, or other specialists in an event that the user is not able or does not have time to provide the information. Similarly, a user may utilize some features of this process 700 to inform an emergency contact that the user is at a hospital, urgent care center, or other medical building, along with the address of the building and any other information that the user would like for the emergency contact to know.

As such, the process 700 begins with the user entering a predefined action into the computing device of the user, where the predetermined action comprises a transmittal of medical and personal information and a transmittal of medical emergency contact information to a second user (e.g., an emergency contact), as shown in block 702.

The medical and personal information that is to be transmitted to the medical organization can be any information that a medical professional at a hospital, urgent care center, or the like would be interested in knowing before operating on the user or providing the user with any medication. The medical and personal information may include, but is not limited to, allergy information for the user, current medication of the user, previous operations of the user, blood type of the user, insurance information for the user, biographical information of the user, resuscitation instructions, medical history of the user, and the like.

The medical emergency notification may be a pre-set message, a set of information that can be populated into a message, or the like, that can be sent to an identified second user (e.g., an emergency contact for the user, a family member of the user, or the like). The predetermined transmittal of the medical emergency notification may include instructions for obtaining global positioning data, mobile device position data, medical building information, or the like to identify a location of the user when the emergency notification is sent out. In this way, the emergency notification may comprise an alert to a second user that the user is at a medical facility at a particular location and may need support. This predetermined action is paired with a triggering signal that will be emitted from a mobile device (which may be the computing device of the user).

Once the user has input the predetermined action, the computing device of the user receives the predetermined action at block 704 and transmits the predetermined action to the managing entity system, as shown in block 706. In some embodiments, additional questions can be asked of the user, by the managing entity system via the computing device of the user. Responses from the user can be populated into their respective fields in a template database of medical and/or personal information of the user. In this way, the managing entity system can help the user put together a complete report to aid the medical organization in addressing any need of the user that brings the user to the medical organization's location to begin with.

The managing entity system, at block 708, receives the predetermined action from the computing device of the user and causes the remote monitoring device to scan an associated geographical region for the triggering signal from a mobile device, as shown at block 710. The remote monitoring device may be positioned at an entrance to a medical facility (e.g., an emergency room entrance, a hospital entrance, an urgent care center entrance, or the like) such that the remote monitoring device is configured to detect the triggering signal of the mobile device as the mobile device is carried into the facility. Additionally or alternatively, the remote monitoring device may be positioned within an ambulance such that the remote monitoring device is configured to scan an area of the ambulance where the mobile device is likely to be present when the user (or the operator of the mobile device, if different from the user) is positioned within the ambulance.

In some embodiments, the managing entity system can cause the mobile device to begin transmitting the triggering signal. In other embodiments, the managing entity system can instruct the mobile device to begin transmitting the triggering signal in response to determining that the mobile device is within a predetermined distance from the medical organization facility (or one of a plurality of medical organization facilities that include a remote monitoring device).

Next, the remote monitoring device scans the geographical region for the triggering signal as shown at block 712. Of course, the mobile may be configured to emit the triggering signal in direct response to receiving a ping or other prompt from the remote monitoring device as well. The remote monitoring device detects the triggering signal at block 714. The detection of the triggering signal indicates that the mobile device (and the user or another associated individual, by proxy) is present at the medical organization facility where the remote monitoring device is located. Therefore, the remote monitoring device may transmit the indication that the triggering signal is detected to the managing entity system, as shown in block 716. This indication that the triggering signal is detected may additionally or alternatively be sent to the robotic process automation system as well (possibly skipping block 718).

At block 718, the managing entity system instructs the robotic process automation system to execute at least a portion of the predetermined action. As mentioned above, when some action steps of the predetermined action have already been completed by the managing entity system, then the instructions to the robotic process automation system are to complete only those remaining action steps from the predetermined action.

As such, the robotic process automation system automatically transmits the medical and personal information of the user to a computing device of the medical organization (e.g., a predetermined computing device of the medical organization configured to receive this information and to present this information on a screen or other display to allow a medical professional to view the information), as shown at block 720, such that the medical organization and its professionals have immediate access to important medical and personal information of the user. As this information is provided to the computing device of the medical organization in real time (or near real time) as the remote monitoring device detects the triggering signal, the medical organization has near instantaneous access to the important medical and personal information of the user without requiring the user to fill out a form, look up insurance information, provide blood type information, provide medical history or allergy information, or the like. In fact, this process 700 will work in scenarios where the user is not able to convey the information manually (person-to-person) anyway.

The computing device of the medical organization receives the medical and personal information of the user at block 722. In some embodiments, the medical and personal information of the user is available for only a predetermined period of time (e.g., as set by the user at block 702, as set by laws or regulations governing medical practice or distribution of medical information, or the like). The computing device of the medical organization may be configured to automatically provide the medical and personal information of the user on a display of the computing device such that a medical professional (e.g., a nurse, an anesthesiologist, a surgeon, an administrative assistant, or the like) can access or view the information in near real time.

In some embodiments, the robotic process automation system may transmit the medical emergency notification to a computing device of the second user, as shown at block 724. For example, the robotic process automation system may determine a name and/or physical address of the medical organization associated with the location of the remote monitoring device and add this information to the medical emergency notification message or instructions as input by the user at block 702 before the notification is emailed, texted, called (e.g., the text of the notification is read aloud over the phone), or the like, to the computing device of the second user (e.g., the emergency contact). In this way, an emergency contact can be immediately identified and contacted as the user is admitted to or otherwise enters a medical organization facility. This process is much more efficient and faster than having an administrative professional at the medical facility request or look up emergency contact information of the user. Additionally, any further information or instructions that the user wishes to provide to the emergency contact, beyond what the medical organization would otherwise provide, can be transmitted to the user as part of the medical emergency notification.

Of course, block 724 can be repeated to provide one or more medical emergency notifications to one or more additional users (e.g., work managers, family members, and the like). The user, at block 702, can generate unique messages or request unique information for each of these one or more additional user, if so desired.

If the system, as described herein, determines that the mobile device is no longer in possession of the user (or the normal operator of the mobile device), then the system can turn off its processes to ensure that transaction amounts, medical information, and personal information are not available to the holder of the mobile device without appropriate re-authentication.

For example, the mobile device of the system may be configured to transmit a different signal (e.g., a key or token associated with the mobile device and the normal triggering signal are adjusted) than the triggering signal when the mobile device is determined to have been compromised. In altering the signal emitted by the mobile device, the system can alert any remote monitoring devices, beacons, or the like, to the fact that the user of the mobile device appears to be an unauthorized user. In response to detecting an altered signal from the mobile device, the monitoring device can cause the robotic process automation system to initiate a rejection process that alerts other robotic process automation systems and other remote monitoring devices or beacons of the compromised nature of the mobile device.

Of course, the system would terminate any actions that are part of the predetermined action originally entered by the user. If a separate computing device of the user is known (i.e., separate from the compromised mobile device), then the robotic process automation system can transmit a notification of the compromised mobile device to the separate computing device. This notification may include location data about where the compromised mobile device has been detected, actions that were attempted with the compromised mobile device, and the like.

Similarly, the robotic process automation system may transmit a notification of the compromised mobile device to a government agency that can help to locate and retrieve the compromised mobile device for the user. To this end, each remote monitoring device can actively scan their respective geographical regions for the altered triggering signal and compile a record of locations and times when the compromised mobile device was detected. This record may indicate a path of the mobile device that can be tracked, extrapolated, and the like to identify a likely future path (e.g., a continuing path, a repeated path, and the like).

If the system receives an indication that the mobile device is no longer compromised (e.g., the user is back in possession), the system can re-instate the initial triggering signal for the mobile device or update the expected triggering signal for the remote monitoring device. In some embodiments, the system may require the user to take the mobile device to a pre-registered location (e.g., a safe location like an office or other location that is unlikely to be accessed by an individual other than the user) before the system will provide a new token, key, or other unique authentication input that can be associated with the triggering signal.

While the user is generally associated with the mobile device in many of the examples described herein, it should be known that any other user could be the owner or operator of the mobile device that transmits the triggering signal. For example, the user may lend credits or a transaction amount to a second user, and instruct the system to cause the mobile device of the second user to transmit the triggering signal instead of a mobile device associated with the original user. In this way, the second user could make a transaction, successfully pass through a toll booth, pump gas, and the like using the system first set up by the original user. As such, the time-based restrictions to the triggering signal can be a helpful technique for setting up temporary profiles or temporary access to the system. For example, a temporary identification tag or triggering signal can be issued to the second user (under the direction of the original user) that is good for a predetermine period of time.

While several examples of how remote monitoring devices and associated robotic process automation systems can be utilized have been described above, it should be known that this list is not limiting, as the functionality of these systems extends beyond the several examples provided herein. For example, another user of the remote monitoring device and robotic process automation system is to trigger a request for payment from each mobile device detected at a table associated with a remote monitoring device.

In other embodiments, the robotic process automation system can prompt each mobile device detected by a remote monitoring device to activate a web browser or other application and access a certain web page or portal. For example, attendees of a wedding, a shower, or the like can be prompted via their mobile devices that are detected by the remote monitoring device to present a gift registry portal associated with the event, along with any personalized messages input by the user when the predetermined action was initially created.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for remotely triggering execution of events by a robotic process automation system in response to detection of a triggering signal, the system comprising:
a memory device; and
a processing device operatively coupled to the memory device, wherein the processing device is configured to execute computer-readable program code to:
receive, from a computing device of a user, a user-defined predetermined action to be performed in response to a remote monitoring device detecting a triggering signal from a mobile device;
cause the remote monitoring device to scan a geographical region for the triggering signal from the mobile device;
receive, from the remote monitoring device, an indication that the triggering signal from the mobile device is received; and
in response to receiving the indication that the triggering signal is received, transmit the triggering signal to a robotic process automation system configured to execute the predetermined action.

2. The system of claim 1, wherein:
the user-defined predetermined action comprises:
a pre-authorization request for a transaction with a merchant at a merchant location, wherein the remote monitoring device is located at the merchant location, wherein the transaction comprises a product or service of the merchant and a known transaction amount or a transaction amount limit; and
an approval to use an account of the user to execute the transaction at the known transaction amount or at or below the transaction amount limit;
the processing device is further configured to execute the computer-readable program code to pre-authorize the transaction with the merchant; and
executing the predetermined action comprises:
transmitting, to a computing device of the merchant, an indication that the transaction is pre-authorized;
receiving a transaction confirmation from the computing device of the merchant; and
in response to receiving the transaction confirmation, transmitting an indication of the transaction confirmation to the mobile device.

3. The system of claim 2, wherein the remote monitoring device is positioned at a location associated with the product or service of the merchant at the merchant location.

4. The system of claim 2, wherein:
the approval to use the account of the user to execute the transaction further comprises an approval to transfer the known transaction amount or the transaction amount limit to a separate account or an escrow account;
the processing device is further configured to execute the computer-readable program code to transfer, prior to causing the remote monitoring device to scan the geographical region, the known transaction amount or the transaction amount limit to the separate account or the escrow account; and
executing the predetermined action further comprises transferring the known transaction amount or the transaction amount limit from the separate account or the escrow account to an account associated with the merchant.

5. The system of claim 1, wherein the processing device is further configured to execute the computer-readable program code to:
cause the remote monitoring device to scan the geographical region for the triggering signal from the mobile device during a predetermined period of time;
receive, from the remote monitoring device, the indication that the triggering signal from the mobile device is received within the predetermined period of time; and
in response to receiving the indication that the triggering signal is received within the predetermined period of time, transmit the triggering signal to the robotic process automation system configured to execute the predetermined action.

6. The system of claim 1, wherein:
the user-defined predetermined action comprises a transmission of medical and personal information associated with the user to a computing device of a medical organization associated with the remote monitoring device, wherein the medical and personal information associated with the user comprises at least user allergy information, user prescribed medication information, user blood type information, and user insurance information; and
executing the predetermined action comprises transmitting, to the computing device of the medical organization, the medical and personal information associated with the user.

7. The system of claim 1, wherein:
the user-defined predetermined action comprises a transmission of a medical emergency notification to a computing device of a second user that is an emergency contact for the user; and
executing the predetermined action comprises transmitting, to the computing device of the second user, the medical emergency notification.

8. A computer program product for remotely triggering execution of events by a robotic process automation system in response to detection of a triggering signal, the computer program product comprising at least one non-transitory computer readable medium comprising computer readable instructions, the instructions comprising instructions for:
receiving, from a computing device of a user, a user-defined predetermined action to be performed in response to a remote monitoring device detecting a triggering signal from a mobile device;
causing the remote monitoring device to scan a geographical region for the triggering signal from the mobile device;
receiving, from the remote monitoring device, an indication that the triggering signal from the mobile device is received; and
in response to receiving the indication that the triggering signal is received, transmitting the triggering signal to a robotic process automation system configured to execute the predetermined action.

9. The computer program product of claim 8, wherein:
the user-defined predetermined action comprises:
a pre-authorization request for a transaction with a merchant at a merchant location, wherein the remote monitoring device is located at the merchant location, wherein the transaction comprises a product or service of the merchant and a known transaction amount or a transaction amount limit; and
an approval to use an account of the user to execute the transaction at the known transaction amount or at or below the transaction amount limit;
the computer readable instructions further comprise instructions for pre-authorizing the transaction with the merchant; and
executing the predetermined action comprises:
transmitting, to a computing device of the merchant, an indication that the transaction is pre-authorized;
receiving a transaction confirmation from the computing device of the merchant; and
in response to receiving the transaction confirmation, transmitting an indication of the transaction confirmation to the mobile device.

10. The computer program product of claim 9, wherein the remote monitoring device is positioned at a location associated with the product or service of the merchant at the merchant location.

11. The computer program product of claim 9, wherein:
the approval to use the account of the user to execute the transaction further comprises an approval to transfer the known transaction amount or the transaction amount limit to a separate account or an escrow account;
the computer readable instructions further comprise instructions for transferring, prior to causing the remote monitoring device to scan the geographical region, the known transaction amount or the transaction amount limit to the separate account or the escrow account; and
executing the predetermined action further comprises transferring the known transaction amount or the transaction amount limit from the separate account or the escrow account to an account associated with the merchant.

12. The computer program product of claim 8, wherein the computer readable instructions further comprise instructions for:
causing the remote monitoring device to scan the geographical region for the triggering signal from the mobile device during a predetermined period of time;
receiving, from the remote monitoring device, the indication that the triggering signal from the mobile device is received within the predetermined period of time; and
in response to receiving the indication that the triggering signal is received within the predetermined period of time, transmitting the triggering signal to the robotic process automation system configured to execute the predetermined action.

13. The computer program product of claim 8, wherein:
the user-defined predetermined action comprises a transmission of medical and personal information associated with the user to a computing device of a medical organization associated with the remote monitoring device, wherein the medical and personal information associated with the user comprises at least user allergy information, user prescribed medication information, user blood type information, and user insurance information; and
executing the predetermined action comprises transmitting, to the computing device of the medical organization, the medical and personal information associated with the user.

14. The computer program product of claim 8, wherein:
the user-defined predetermined action comprises a transmission of a medical emergency notification to a computing device of a second user that is an emergency contact for the user; and
executing the predetermined action comprises transmitting, to the computing device of the second user, the medical emergency notification.

15. A computer implemented method for remotely triggering execution of events by a robotic process automation system in response to detection of a triggering signal, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a computing device of a user, a user-defined predetermined action to be performed in response to a remote monitoring device detecting a triggering signal from a mobile device;
causing the remote monitoring device to scan a geographical region for the triggering signal from the mobile device;
receiving, from the remote monitoring device, an indication that the triggering signal from the mobile device is received; and
in response to receiving the indication that the triggering signal is received, transmitting the triggering signal to a robotic process automation system configured to execute the predetermined action.

16. The computer implemented method of claim 15, wherein:
the user-defined predetermined action comprises:
a pre-authorization request for a transaction with a merchant at a merchant location, wherein the remote monitoring device is located at the merchant location, wherein the transaction comprises a product or service of the merchant and a known transaction amount or a transaction amount limit; and
an approval to use an account of the user to execute the transaction at the known transaction amount or at or below the transaction amount limit;
the computer implemented method further comprises pre-authorizing the transaction with the merchant; and
executing the predetermined action comprises:
transmitting, to a computing device of the merchant, an indication that the transaction is pre-authorized;
receiving a transaction confirmation from the computing device of the merchant; and
in response to receiving the transaction confirmation, transmitting an indication of the transaction confirmation to the mobile device.

17. The computer implemented method of claim 16, wherein:
the approval to use the account of the user to execute the transaction further comprises an approval to transfer the known transaction amount or the transaction amount limit to a separate account or an escrow account;
the computer implemented method further comprises transferring, prior to causing the remote monitoring device to scan the geographical region, the known transaction amount or the transaction amount limit to the separate account or the escrow account; and
executing the predetermined action further comprises transferring the known transaction amount or the transaction amount limit from the separate account or the escrow account to an account associated with the merchant.

18. The computer implemented method of claim 15, further comprising:
causing the remote monitoring device to scan the geographical region for the triggering signal from the mobile device during a predetermined period of time;
receiving, from the remote monitoring device, the indication that the triggering signal from the mobile device is received within the predetermined period of time; and
in response to receiving the indication that the triggering signal is received within the predetermined period of time, transmitting the triggering signal to the robotic process automation system configured to execute the predetermined action.

19. The computer implemented method of claim 15, further comprising:
the user-defined predetermined action comprises a transmission of medical and personal information associated with the user to a computing device of a medical organization associated with the remote monitoring device, wherein the medical and personal information associated with the user comprises at least user allergy information, user prescribed medication information, user blood type information, and user insurance information; and
executing the predetermined action comprises transmitting, to the computing device of the medical organization, the medical and personal information associated with the user.

20. The computer implemented method of claim 15, wherein:
the user-defined predetermined action comprises a transmission of a medical emergency notification to a computing device of a second user that is an emergency contact for the user; and
executing the predetermined action comprises transmitting, to the computing device of the second user, the medical emergency notification.
